(19) United States
(12) Patent Application Publication
(10) Pub. No.: US 2014/0026036 A1
(43) Pub. Date: Jan. 23, 2014

(54) PERSONAL WORKSPACES IN A COMPUTER OPERATING ENVIRONMENT

(71) Applicant: NBOR CORPORATION, Moraga, CA (US)

(72) Inventors: Denny Jaeger, Lafayette, CA (US); Alastair Brown, Berkshire (GB)

(73) Assignee: NBOR CORPORATION, Moraga, CA (US)

(21) Appl. No.: 14/036,697

(22) Filed: Sep. 25, 2013

Related U.S. Application Data
(63) Continuation-in-part of application No. 13/560,006, filed on Jul. 27, 2012.
(60) Provisional application No. 61/513,038, filed on Jul. 29, 2011.

(51) Int. Cl. G06F 17/24

(52) U.S. Cl. CPC G06F 17/24
USPC 715/234

(57) ABSTRACT

The present invention generally comprises a computer control environment that builds on the Blackspace™ software system to provide further functionality and flexibility in directing a computer. It employs graphic inputs drawn by a user and known as gestures to replace and supplant the pop-up and pull-down menus known in the prior art.

### CROSS-REFERENCE TO RELATED APPLICATIONS

This application claims the priority date benefit of Non-Provisional patent application Ser. No. 13/560,006, filed Jul. 27, 2012, which claims priority data benefit from Provisional Application No. 61/513,038, filed Jul. 29, 2011, which are both incorporated herein by reference.

### FEDERALLY SPONSORED RESEARCH

Not applicable.

### SEQUENCE LISTING, ETC ON CD

Not applicable.

### BACKGROUND OF THE INVENTION

1. Field of the Invention

The invention relates generally to computer operating environments, and more particularly to a method for performing operations in a computer operating environment.

2. Description of Related Art

For decades websites have been used as a source of information for research, analysis, advertising, marketing and sales, communication, entertainment and a nearly endless host of other activities. But through all this time websites have remained programmed structures that are generally fixed, usually governed by HTML tables or the like, and not capable of being user-modified.

### SUMMARY OF THE INVENTION

The present invention generally comprises a computer control environment that enables a user (including a non-software programmer) to modify, manipulate, alter, append, add-to or otherwise change the presentation of the structure and/or content of any network media, including any existing or newly created website or any network or cloud environment. The software of this invention permits a user to employ graphic, gestural, verbal, software and other inputs to alter existing content, organization schemes and structures, logic, data flow or anything else associated with the viewing or operation of network media, including any website and its content. The software of this invention permits the creation of user-generated content its storage and retrieval from any network structure, including any website or its equivalent. Further, the software of this invention permits the above described processes to be fully automated and/or be the result of an automatic software controlled operation.

### BRIEF DESCRIPTION OF THE DRAWING

FIG. 1 is a block diagram depicting a computer system capable of carrying out the operations of the present invention.

FIG. 2 is a flow chart depicting the steps required to load content for a web page.

FIG. 3 is a flow chart depicting the steps for drawing on a web page.

FIGS. 4A-4D illustrate a method for the use of “digital paint” via selecting color from a touched point in a VDACC browser.

FIGS. 5A-5G illustrate a method of defining a texture that is used as “digital paint” associated with a website in a VDACC browser.

FIGS. 6A-6D illustrate an analysis of individual paint strokes in a VDACC browser to define a digital painted space.

FIGS. 7A-7D illustrate establishing a toggle relationship between a digital painted space and devices on a website in a VDACC browser.

FIG. 8 is a flowchart illustrating the operation of an ASC device.

FIG. 9 depicts four items in a Graphic Scene.

FIG. 10 is an illustration of the layers of items in the Graphic Scene of FIG. 9.

FIG. 11 illustrates items rendered in the Graphics View.

FIG. 12A shows a Graphics Scene containing a VDACC with two ‘children’ VDACCs.

FIG. 12B shows a Graphics Scene with a child VDACC cropped by the parent VDACC.

FIG. 12C shows the relative layers of a parent VDACC and two “children” VDACCs.

### DETAILED DESCRIPTION OF THE INVENTION

The present invention permits users to alter existing network media and create new ones utilizing a set of graphical tools, means and methods provided in software. Network media as referred to herein, means any website, community, social media environment (including all media and environment elements, e.g., devices, structure, operational logic and content or their equivalent) or pertaining to any media, organization, group, structure, 2-D or 3-D environments and websites that are presented over or via any network, including any internet or its equivalent, including any cloud infrastructure (“network media”).

Further, this invention permits users to create any digital content, user defined operations, logic, paths, data structures, objects, object relationships, contexts, layers or their equivalent for any network media. Further, this invention permits a user to protect, assign, designate or otherwise associate their personal identification information (“User ID”) with any network media. One result of the use of a User ID is that if a user, other than the user who has associated their User ID with a network media, accesses the URL for a network media that has been attached with a specific user's ID, none of the personal information that has been added to that network media by said specific user will be visible or accessible to anyone who does not input said user's ID information to a digital system.

Personal Workspaces enable a user to conduct research, organize data, share and collaborate with data, more effectively create user-generated data, store and archive data, and create and utilize a new media, including BSPs (Blackspace Pictures). Note: One concept of personal workspaces is that any user can take any website and add data to it and/or modify data within said website or otherwise alter said data to enable said website to be used for anything a wide variety of purposes. This includes, but is not limited to, utilizing a website or other network environment as a personal vehicle and/or means and/or method for a user to archive data, provide, utilize, update and maintain a workspace, a data storage facility, perform collaboration, share data in real and non-real time, and create, modify, share and deliver user-generated content.

One notable value of such a workspace is that is can be created, utilized and maintained as a live website on the internet, intranet or any other network, cloud service or the like. The advantages of this are that the data added to any network media can be archived. For business and education purposes this has strong advantages for the user.

Students can use personal workspaces as research tools, archiving and storage of user-generated content for homework and school assignments, collaboration, real time and non real time data sharing and more. Professionals can use personal workspaces for the same purposes. For example legal counsel can use personal workspaces to store and present legal briefs, arguments, case history and the like.

As a further example, let's say a student in a school created a personal workspace for a drawing class. Here's how this could work. The student could enter their user ID to a digital system and create a personal workspace, or create the personal workspace and then user their user ID information to save their personal workspace. The user's account information would include information specific to the user as common in the art, for example, a user name and a password and/or a biometric of the user, e.g., a retinal scan, finger print, or their equivalent. Once the user ID information is recognized by a software system, the ability to view, interact with, create, delete or modify content, and utilize and maintain or otherwise interface with a personal workspace of any kind, means or method is linked to the specific users who entered their ID information.

The user, in this example an animation student, would search a network to find a network media that contains some of the information they need to address one or more parts of their school assignment. Once they find a network media that contains useful information, they can turn that network media into their own personal workspace.

One way to approach an understanding of the software tools, means and methods of this invention is to look at what tools have been used for centuries for teaching and learning. Categorically and generically speaking, these tools include following: a writing tool (a scribe, charcoal, pencil, pen, etc.), a writing surface (a rock, tree bark, paper, cloth, etc.) a straight edge (a rock, branch, piece of wood, ruler, etc.) something to store things in (a box, bag, backpack, folder, booklet, etc.) The software of this invention considers these same tool types and the historical experiences in using these tools and puts them into a computing environment with a familiar ease of use. In other words, the tools of this invention are based on the way people have interfaced with information for hundreds of years.

In the software of this invention, the writing tool is a digital pen or finger or gesture. The writing surface can be a single integrated “canvas.” This canvas contains all objects that a user interfaces with. Furthermore, the layering system, supporting the use of the objects on the canvas, is fashioned after real life layers. As an example, if a hundred objects are sitting on a canvas and none of these objects intersect each other, there is a layer of 1 for each object. So a user can interface with each of these objects directly. This becomes particularly powerful when one wishes to undo any one of these object's actions or operations without affecting any of the other objects. Furthermore, if multiple objects intersect each other, the layers are associated only with those objects, just like a pile of papers on one's desk. A user would go right to the “pile” of data they want and deal with it and this doesn't affect any other object on the canvas that are not part of that “pile” (layering group). The straight edge is simple. Software enables anyone to make a straight line.

In an exemplary embodiment, the method in accordance with the invention is executed by software installed and running in a computing environment. The method is sometimes referred to herein as the “software”. The method is described herein with respect to a computer environment referred to as the Blackspace” environment. However, the invention is not limited to the Blackspace environment and may be implemented in a different computer environment. The Blackspace environment presents one universal drawing surface that is shared by all graphic objects within the environment. The Blackspace environment is analogous to a giant drawing “canvas” on which all graphic objects generated in the environment exist and can be applied and interacted with. Each of these objects can have a relationship to any of all the other objects. There are no barriers between any of the objects that are created for or that exist on this canvas. Users can create objects with various functionalities without delineating sections of screen space

Personal workspaces are a valuable method for storing any data or the like and enabling user-generated content. For instance, a user can create a personal workspace for each subject or for each assignment they have in school. These personal workspaces can be easily archived by storing the user-generated data on a server or locally or both. Since the websites are “live”, they update themselves automatically. So they will remain a source for modern and up-to-date research. Yet the user-generated data remains accessible and unchanged. So a student can re-use any of their user content for any personal workspace years after they created it. Thus their user content becomes a source for future research.

Improving the Ability to Learn, Teach, Collaborate and Share

By combining the following elements students have an improved ability to conduct research, organize their research, express themselves creatively and to communicate with each other, with their teachers, and their teachers with them. These elements include but are not limited to:

Assignments—the ability to assign data to any object by drawing and/or gestures. This further includes the ability to place and operate an assigned-to object anywhere in a computing environment, like personal workspaces, and includes the ability to email said any object outside the computing environment in which it was created.

Global Drawing Canvas—a computer environment that supports pixel accurate, user-driven functions on a single operating surface.

The VDACC—an object that manages other objects on a global drawing canvas, permitting, in part, websites to exist as annotatable objects in a computer environment. Regarding VDACC objects and IVDACC objects, see “Intuitive Graphic User Interface with Universal Tools,” Pub. No.: US 2005/0034083, Pub. Date: Feb. 10, 2005, incorporated herein by reference.

A VDACC is a defined onscreen workspace manager that does not have any simple counterpart in prior art computer terminology, such as a window, desktop, dialog box, or the like.

A VDACC is a graphic user interface for an electronic device with a display which can include the following:

(1) A global drawing surface on which different graphic elements can be created, said different graphic elements existing on said global drawing surface; and

(2) A display-and-control graphic element on said global drawing surface having a local drawing surface on which additional graphic elements can be created, said display-and-control graphic element having a viewable area that can selectively display a portion of said local drawing surface such that some of said local drawing surface is not displayed, said display-and-control graphic element being configured such that said additional graphic elements on said local drawing surface are managed by said display-and-control graphic but exist on said global drawing surface, wherein a first graphic element of said additional graphic elements is displayed in said display-and-control graphic element on the local drawing surface and a second graphic element of said different graphic elements is displayed outside of said display-and-control graphic element on the global drawing surface, and wherein said second graphic element outside of said display-and-control graphic element has a defined operational relationship with said first graphic element in said display-and-control graphic element such that one of said first and second graphic elements is controlled by the other element of said first and second graphic elements so that a functionality of said one of said first and second graphic elements is controlled by said other element, wherein said defined operational relationship between said first and second graphic elements is maintained even when said first graphic element is moved outside of said display-and-control graphic element onto said global drawing surface.

VDACCs are not Separate Windows.

VDACCs are graphic objects that are part of the software's global drawing surface. As objects on a global drawing surface VDACCs can interact with other objects that are not VDACCs. VDACCs are organizational tools for working in Blackspace.

VDACC is a Graphic Object Manager.

The VDACC allows all of the objects within its perimeter to be grouped together (agglomerated within it). However, all these objects always exist on the global drawing surface, Blackspace. The VDACC itself is a graphic object. But in addition to its own graphical elements, such as a background which can be opaque to transparent, a close and maximize switch and a resize switch, it also owns a data object called a graphic linker. This linker is a list of graphic objects that are managed by the VDACC. Operations such as moving and resizing generally operate first on the VDACC itself and then on the list of objects held in the graphic linker.

All the Functionality of Blackspace can be Available in Every VDACC.

VDACCs have no individual programmed uniqueness that separates one VDACC from another. All VDACCs have exactly the same operability and capability. What makes each VDACC different is what the user puts into them and the arrows that are drawn to create functions and actions between one or more objects in one or more VDACCs and in Blackspace itself. In fact, there is only Blackspace as an operational environment; Blackspace is the only drawing surface.

VDACCs are not Operational Boundaries on a Global Canvas.

VDACCs are not programming boundaries to the software with regards to how it utilizes its global drawing surface. VDACCs are organizational structures that group graphical items together according to a user's discretion. VDACCs do not have their own independent drawing surfaces; they manage one or more objects that exist on a global drawing surface. This management role has two overall aspects:

1. The physical location and alteration or manipulation of the appearance of the graphical objects in Blackspace.
2. The association and/or linking of actions, functions and operations from one or more objects to one or more other objects in Blackspace.

In the case of aspect 2, the linking is always on the global drawing surface, as VDACCs do not act as barriers to this drawing surface; VDACCs act as organizational tools for Blackspace. The VDACCs appear to users as separate entities, which may appear to be akin to windows, but (as noted above) they are not windows in any regard.

When a VDACC has been created in Blackspace, what has been created is an object that is a manager for other graphical objects, which can be moved scrolled and clipped by the rectangular outline of the VDACC. However, the objects are still being drawn on a global drawing surface. So these objects have the ability to interact with other objects in Blackspace and/or in other VDACCs. This is directly the opposite of the Windows environment in which you have individual windows that represent unique and completely self-contained environments that are designed by a programmer. So the behavior of conventional windows is controlled by computer programs written by programmers not the user.

When a user drags an object so that the tip of the mouse cursor, finger, pen or its equivalent that is being used to drag that object is within the perimeter of a VDACC, that object “clips” into the VDACC. The term “clip” with respect to VDACCs is described in more detail blow in sub-section D-8. The VDACC's data structures then know about that item and manage this item. This item can be moved and scrolled along with all the other items being managed by the VDACC, but the VDACC is managing them on one global drawing surface, Blackspace. All graphic items, such as drawings, recognized objects, pictures, text, videos or music that are placed on a VDACC remain part of the Blackspace global drawing surface.

The VDACC uses Blackspace by manipulating the items on it that are clipped to the VDACC. When a VDACC containing objects that have been clipped into it is moved, all these clipped objects' data structures are moved with the VDACC. This is accomplished by the VDACC telling its objects where to go to, by adding X and Y coordinate offsets to all of the objects that are within its data structure, even if the objects are not within its perimeter.

Items can be dragged to a VDACC that are much larger than the visible surface area of the VDACC. But if the tip of the mouse cursor is within the perimeter of the VDACC when a mouse up-click is performed, the dragged item will be clipped into the VDACC and the VDACC's internal area will be automatically enlarged to accommodate the larger item, even though its full size will not be visible by looking at the available surface area of the VDACC. However, after being clipped into a VDACC these larger items produce one or more “scrollers” to appear along one or more edges of the VDACC. These clipped items can then be scrolled so they can be viewed through the available surface area of the VDACC. It should be noted that when the visible surface area of a VDACC is smaller than its full working area, the VDACC can be scrolled to view items clipped to the VDACC that are outside the visible perimeter of a VDACC as needed, since clipped items are not visible unless they are within the visible perimeter of the VDACC.

A VDACC Provides a Clipping Mechanism for Drawing and for Placing Graphics within it.

A VDACC will not allow the items that it contains to be visible except those parts of these items that are within the borders of the VDACC. One may argue that this is the same process that governs the operation of a window, but there is a key difference here. The objects being scrolled in a VDACC are not separated from the rest of the objects onscreen. The objects are merely being managed by the VDACC as they exist on the Blackspace global drawing surface. Since they exist on a global drawing surface, they can directly interact with any other object on that drawing surface whether that object is in another VDACC or sitting directly on the global drawing surface. So a VDACC does not present any type of impediment to the immediate and direct interaction of any object with another object in Blackspace.

VDACCs can be Controlled by Users.

Users control what is managed by a VDACC by what the users put into the VDACC and where they put it. Whatever is put into a VDACC, no matter how complicated it may be (for example, 100 pages of documentation), those materials remain a part of the Blackspace global drawing surface. VDACCs are portals onto this global drawing surface and manage groups of objects without limiting their functionality.

In a comparison, users cannot create their own window in a Windows environment. Only programmers can do this. In Blackspace, however, users can create their VDACCs by many means, including but not limited to: drawing means, typing means, dragging means, verbal means, context means, and via collaboration.

What happens when a user creates a VDACC? How does the VDACC know it controls a part of Blackspace and that this “part” is not unique to that VDACC? Also how does a VDACC share this “part” of Blackspace with the many other VDACCs that may be on the same Blackspace global drawing surface?

A VDACC is a container for graphical objects. Objects that are dragged to the VDACC where the tip of the mouse cursor is within the perimeter of the VDACC when an up-click is performed become managed by that particular VDACC. The VDACC controls the position of objects within it, but the user determines what those objects are.

If you have a window, the programmer for that window's application decides what is in it and what you can do with it and what the rules are for operating it. In Blackspace, the user can decide what is in or on a VDACC. Drawn inputs can control the operations or rules for engaging with the objects on a Blackspace global drawing surface, including objects that are managed by separate VDACCs.

A VDACC is created in Blackspace or within another VDACC by a user to manage onscreen objects that may be drawn or otherwise created, contained and recalled. The onscreen objects may be combined in functional relationships, assigned to other onscreen objects, operated, revised, edited, added to, or otherwise used to carry out the intent of the user. Any number of VDACCs may be created and presented onscreen. Any onscreen object may be contained within a VDACC, moved between VDACCs, or assigned, linked and or controlled by or in control of any other object within any other VDACC.

A VDACC is a Graphic Object.

A VDACC is itself an onscreen object. A VDACC appears onscreen with a definable (i.e., rectangular) perimeter defined by a continuous line. In fact, any closed perimeter shape defining an interior space may be used as a VDACC, whether a circle, octagon or any other polygon or free drawn shape. The operations (including user-defined operations) of a VDACC are carried out by the software, which controls the computer, provides all interface interactions with the user, generates all the VDACCs, and carries out all the various computer functions that in the prior art are divided among a large multitude of separate programs running under an operating system.

Clipping.

An aspect of a VDACC is called “clipping.” All objects that become part of a VDACC's management system are “clipped” to that VDACC. Clipping occurs when an object is dragged to a VDACC such that the tip of the mouse cursor dragging the object is within the perimeter of the VDACC when a mouse up-click is performed.

An additional aspect of clipping is the fact that a VDACC's usable surface area automatically increases if an object is clipped into it where the object's perimeter exceeds the visible perimeter of the VDACC. In other words, if something bigger than the size of a VDACC is placed into that VDACC, the VDACC's working surface expands automatically.

The larger object is then made accessible therein by scrollers appearing automatically along one or more edges of the VDACC. Thus the internal working surface of a VDACC may be far larger than the visible perimeter. Furthermore, if this larger object that is clipped into the VDACC is removed from the VDACC, then the VDACC is automatically resized to equal the size of the next largest item still clipped into it.

Blackspace.

Blackspace is a software that presents one universal drawing surface that is shared by all graphic objects in the software. Blackspace is analogous to a giant drawing “canvas” on which all graphic items generated by the software exist and can be applied. Each of these objects can have a user-created relationship to any or all the other objects. There are no barriers between any of the objects that are created for or exist on this canvas.

Underlying the use of the set of universal tools are several concepts that are fundamental to the invention. These are: the context in which the tools are used and combined, assignment of functionality to onscreen objects or computer items, and the use of equivalents to represent tools or computer items. In turn, underlying these concepts are elements that enable the realization or actualization of these universal tool concepts. These elements are:

Object Recognition of hand drawn inputs.

Arrows and Arrow Logics

VRT Virtual Recall Tool—previously named Digital Recall Tool

VDACCs.

Layering.

Info Canvases

Contexts

Specifiers and Known Text

Layering System Based Upon Object Intersection—the determination of the layering of objects and their individual undo stacks is based upon each object's intersection with one or more objects. Regarding enabling websites to be embedded in the layering system of Blackspace, see the section below, entitled: “Managing a Website as the Background of a VDACC.”

The BSP (Blackspace Picture)—the ability to save any environment or collection of objects, actions, functions, operations and the like, as a picture. A BSP can be shared as a simple .jpg or .png image outside of the Blackspace environment. But inside the Blackspace environment it can be used to create a new interactive media. As a media, one or more BSPs can be used to create interactive eBooks, interactive slide shows, interactive videos, and interactive pictures.

Recognized Objects—the ability to free draw geometric objects that are recognized by software and converted into computer rendered objects. These objects can then be used for the assignment of data, facilitating the storage and recall of data, the sending of data, sharing of data, and real and non-real time collaboration using data.

Real Time Data Sharing of Matched Computer Environments—the ability to share data where the data is built or presented via software in one or more environments participating in the data sharing.

Visual Bookmarks—the ability to convert user-generated or user-selected content to navigational structures for accessing data on any network.

Teacher/Student Assessments Via Personal Workspaces

This problem of accurately assessing a student's progress has been growing for years and has become an educational epidemic in many countries. Personal workspaces and the elements described herein can be combined to offer a solution to this problem. Students can create personal workspaces that contain not only their research, but their homework and any other school project assignments. Teachers can go a network, i.e., an internet, a school intranet, cloud services on the internet and/or peer-to-peer to access a student's personal workspace. The teacher can assess both the result of the student's assignment as well as the student's choices and methods of research, comments regarding that research, collections of data, and other pertinent student inputs made to their personal workspaces. Thus a teacher can more effectively guide, counsel, instruct, assess and grade a student's performance via that student's personal workspaces. The personal workspaces can contain the history of the student's research, content creation, assignment responses. In short, a student's personal workspace can supply a teach with a history and view of that student's thought process as well as work product.

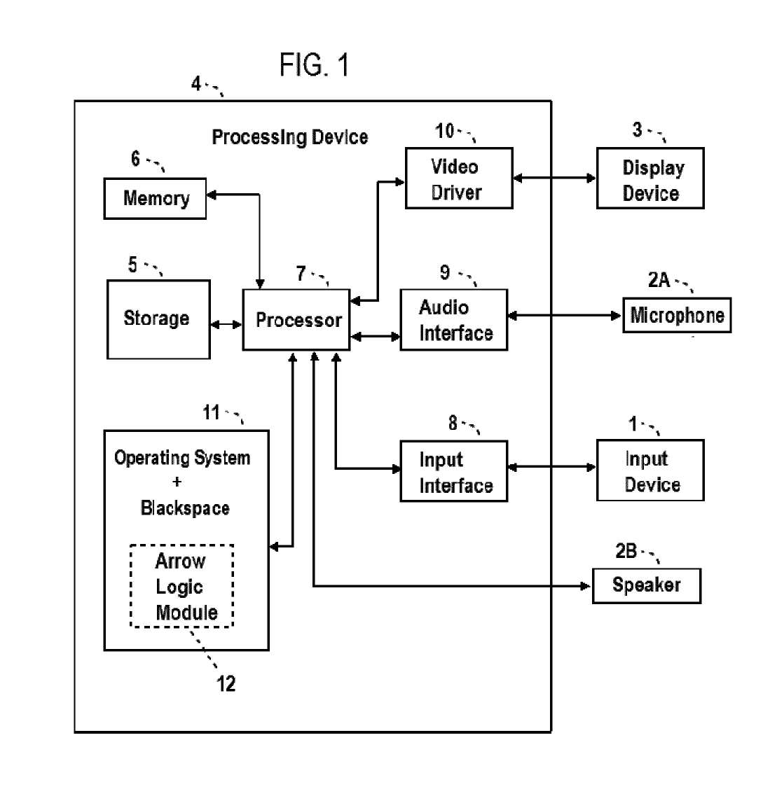

Referring to FIG. 1, the computer system for providing the computer environment in which the invention operates includes an input device 1, a microphone 2A, a speaker 2B, a display device 3 and a processing device 4. Although these devices are shown as separate devices, two or more of these devices may be integrated together. The input device 1 allows a user to input commands into the system to, for example, draw and manipulate one or more arrows. In an embodiment, the input device 1 includes a computer keyboard and a computer mouse. However, the input device 1 may be any type of electronic input device, such as buttons, dials, levers and/or switches, camera, motion sensing device input and the like on the processing device 4. Alternatively, the input device 1 may be part of the display device 3 as a touch-sensitive display that allows a user to input commands using a finger, a stylus or devices. The microphone 2A is used to input voice commands into the computer system. A speaker 2B is used to output audio signals from the computer system. The display device 3 may be any type of a display device, such as those commonly found in personal computer systems, e.g., CRT monitors or LCD monitors.

The processing device 4 of the computer system includes a storage 5, memory 6, a processor 7, an input interface 8, an audio interface 9 and a video driver 10. Storage 5, could be any device, including a disk drive for any computing system, or permanent storage, e.g., flash RAM, memory card or the equivalent for any mobile device, pad or the equivalent. Input device 8, could include any peripheral device, e.g., USB, FireWire and Blue Tooth. The processing device 4 further includes a Blackspace User Interface System (UIS) 11, which includes an arrow logic module 12. The Blackspace UIS provides the computer operating environment in which arrow logics are used. The arrow logic module 12 performs operations associated with arrow logic as described herein. In an embodiment, the arrow logic module 12 is implemented as software. However, the arrow logic module 12 may be implemented in any combination of hardware, firmware and/or software.

The disk drive 5, the memory 6, the processor 7, the input interface 8, the audio interface 9 and the video driver 10 are components that are commonly found in personal computers. The disk drive 5 provides a means to input data and to install programs into the system from an external computer readable storage medium. As an example, the disk drive 5 may a CD drive to read data contained therein. The memory 6 is a storage medium to store various data utilized by the computer system. The memory may be a hard disk drive, read-only memory (ROM) or other forms of memory. The processor 7 may be any type of digital signal processor that can run the Blackspace software 11, including the arrow logic module 12. The input interface 8 provides an interface between the processor 7 and the input device 1. The audio interface 9 provides an interface between the processor 7 and the microphone 2 so that use can input audio or vocal commands. The video driver 10 drives the display device 3. In order to simplify the figure, additional components that are commonly found in a processing device of a personal computer system are not shown or described.

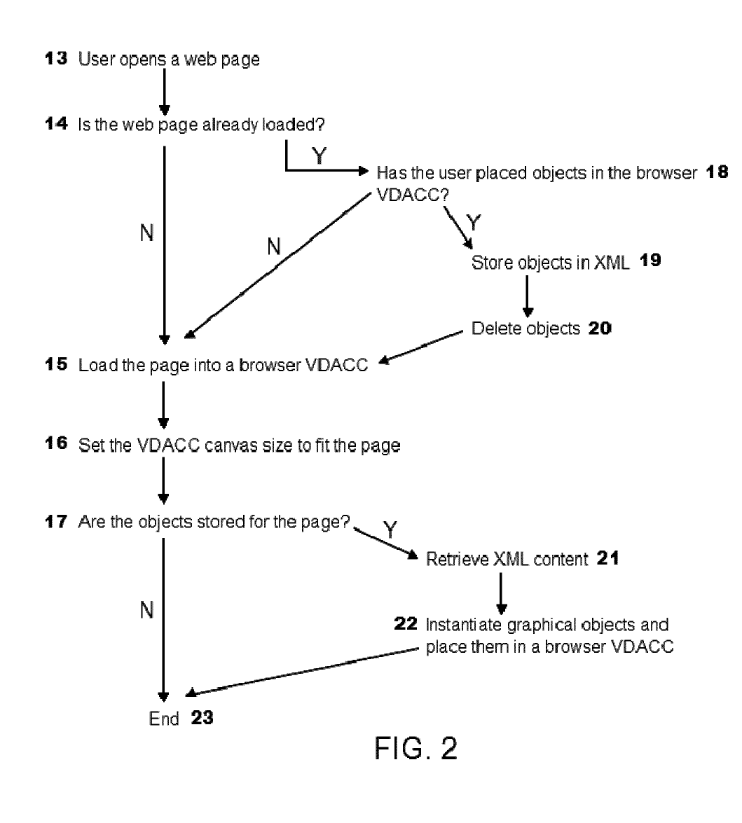

FIG. 2 is a flow chart illustrating the placement of data into a personal workspace web browser. With the software of this invention, network media, like a website and its content, devices, structure or its equivalent can exist as an object. Said network media can be a VDACC object or be contained within or managed by a VDACC object (see patent application publication # US 2005/0034083). As such the network media and its content can exist as the background image for said VDACC. In a key embodiment of this invention, the ability to input content (e.g., via drawing, dragging, verbal means, context means, via gestural means, software means, mental control means or any other means that can be input into a computer system) to any network media occurs as a result of the network media, existing in a VDACC as a background image or as content managed by said VDACC.

Also of note is the ability to save and recall any one or more objects and their placement in a network media. One approach to achieving the saving and recalling of user data or other data added to a network media is by assignment. In this case, all objects placed into a network media (e.g., a web page) are automatically assigned to that web page via the software. So when the website is navigated to another page and then returned to a page where there exists added data, said data reappears automatically as part of its assignment to that web page. Among other things, a VDACC can both manage data and have data assigned to it.

One of the benefits of assigning data to a VDACC is that when a user recalls the VDACC they can automatically recall the assignments to it. In the case of websites, any number of websites, as objects or as HTML data or represented as other data types, can be represented as a group of easily managed pieces of data.

Referring to FIG. 2, this flowchart contains the following steps.

a. Step 13: The user opens a web page. This can be any webpage.
b. Step 14: The software checks to see if the web page is loaded.

Step 15: If “no”, then the software loads the web page into a browser VDACC.

Referring again to Step 14, if “yes”, the software checks to see if the user has placed one or more objects in the browser VDACC. If “no,” the software goes to Step 15. If “yes,” the software goes to Step 19.

Step 19: The software stores the objects in XML or some other suitable means.

Step 20: The software deletes the objects, then goes to Step 15.

Step 16: Then the software sets the VDACC canvas size to fit the page. This could be a user-definable action or an optional action.

Step 17: The software checks to see if the objects on the page are stored. If “yes” the software goes to Step 21. If “no,” the process ends.

Step 21: The software retrieves the XML content.

Step 22: The software instantiates the graphic objects and places them in a browser VDACC.

Step 23: The process ends.

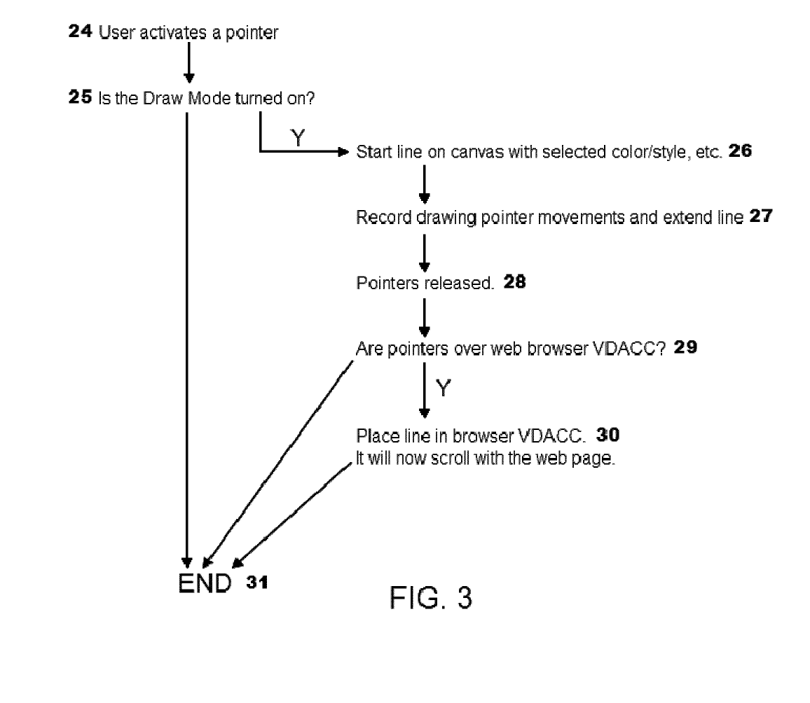

FIG. 3 depicts a flowchart showing the process of drawing on a personal workspace website. FIG. 3 contains the following steps:

Step 24: The user activates a pointer.

Step: 25: A query is made to determine if the Draw Mode is turned on. Note: a draw mode is any enabling of the ability to draw in an environment. The drawing can be enabled by any viable means or method, including gestures, verbal input, pen, finger, mouse, pad, touch screen, mental input or the equivalent.

Step 31: If “no” the process ends.

Step 26: If “yes” a line is started on a canvas with a selected line color, style, etc. Any viable input can be used to start a line, including a pen, finger touch, gesture, software generated input, or the equivalent. The choice of a line style can be according to a computer software default, context, relationship, user input or any other viable input.

Step 27: The pointer movements are recorded and the line is extended.

Step 28: The pointers are released.

Step 30: a line is placed in a browser VDACC such that it is scrolled with the web page.

Step 31: the process ends.

Note: essentially the same process as described in FIG. 3 can be used to presenting pictures, videos, websites, other personal workspace in a web page or other network media.

Digital Paint (“Digital Whiteout”)

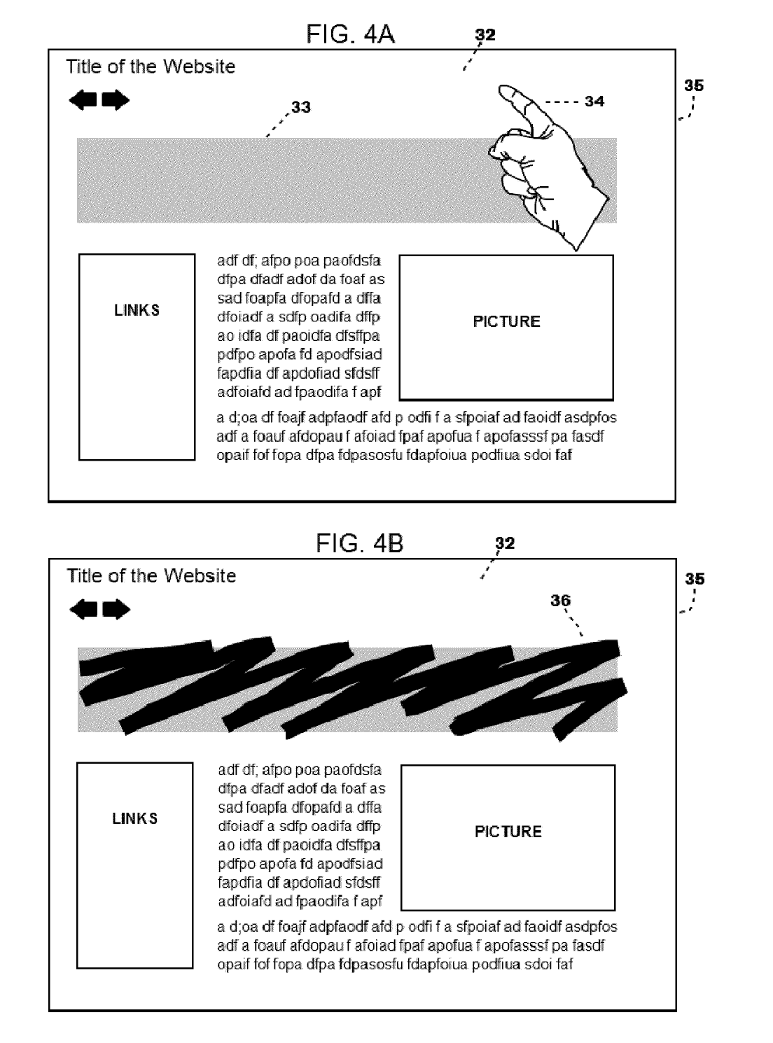

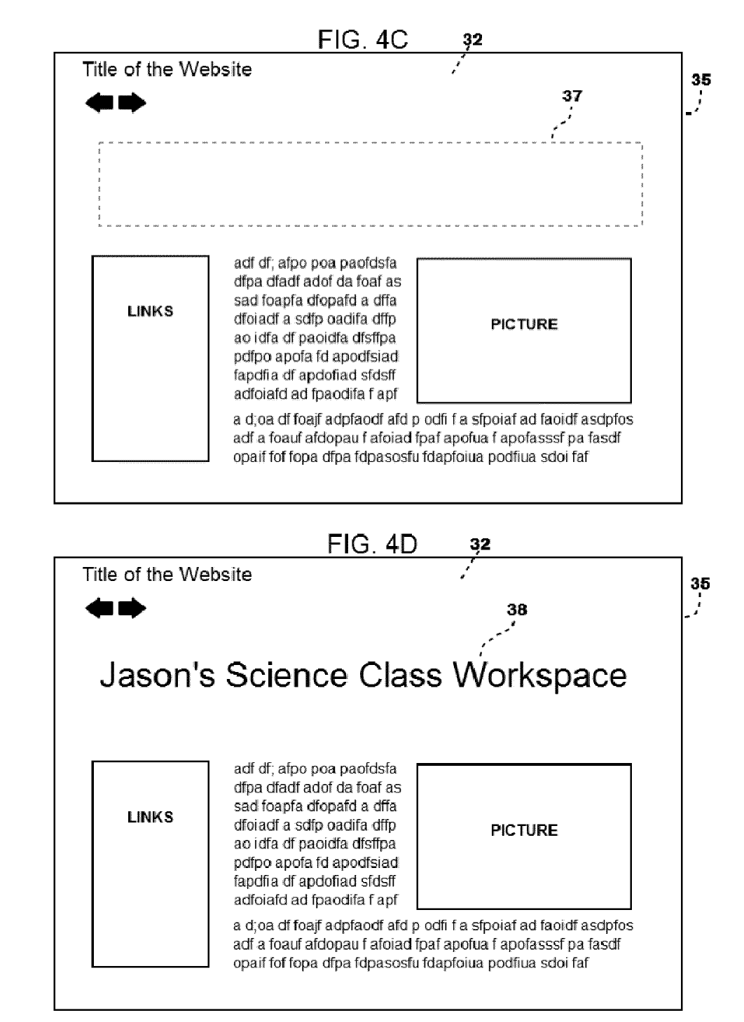

FIGS. 4A-4D illustrate a method for the use of “digital paint” or “digital whiteout” as we sometimes refer to it. Using this method, an input (pen, finger, verbal, software generated, context, assignment, mental input, or the like) is used to touch any color on any object, text, background, video, picture, animation or any item on any network media. The color that was touched would become the selected color and then it could be used to draw on any network media. Note: the opacity or transparency of said color would be adjustable to any level. Referring to FIG. 4A, a finger 34 touches a point on a website 32 in a VDACC 35. The software of this invention captures the color of the touched point.

FIG. 4B the color captured by the touching of a point on the website is used to draw over a banner ad video 36 on the website. Note: the color black was used to show the drawing of the color so it is visible in this figure. In reality, the color white would be drawn over the banner ad video. The purpose of this drawing is to remove the banner ad video from the website so the user can reclaim this space and use it for their own purposes. There are many ways to “whiteout” the website banner ad video. These methods include, but are not limited to, the following.

Method 1: Scribble over the banner ad video 33 with a selected color. The software recognizes the scribble 36 and applies an object that equals the outer perimeters defined by the scribble, such that the object obscures the website banner ad video.

Method 2: The user carefully uses the selected color to paint over every portion of the banner ad video 33 so it is completely obscured by the drawing of the selected color.

Method 3: Using the selected color, the user draws an outline around the banner ad video 33 and the software automatically fills in the drawn outline with the selected color to completely obscure the banner ad video 33.

Method 4: A verbal utterance can be used to utilize the selected color to obscure the banner ad video 33. For instance, a user could touch the banner ad video and then say “paint over” or “whiteout” or any other verbal utterance that equals this action. The software would then place an object 37, which matches the selected color, over the banner ad video 33.

FIG. 4C illustrates the result of the “painting” of the selected color over the banner ad video on the website 32 in the VDACC 35. The banner ad video is no longer visible since is it now obscured by an object 37 that matches the selected color, which in this example matches the color of the background of the website 32.

FIG. 4D depicts a user typing their own heading 38 for their personal workspace over the object 37 that now obscures the banner ad video 33. To the user, the banner ad video is gone and will not return or become visible unless the user removes the object 37 that obscures it.

A second method to call forth digital paint would be to encircle (via any suitable means, (i.e., drawing, a gesture, verbal utterance, computer generated action or the like) an area of an object, text, background, video, picture, animation or the like on any “network media”. A network media is any media that can exist on a network. This encircling itself could call forth digital paint if the software recognized it as a context for activating digital paint. Otherwise, the gesture could be combined with some occurrence, like a verbal utterance, a computer generated action, a selection of some kind, activating an object or any other action or operation that can cause the gesture to cause the software to capture the texture encircled by the gesture.

This encircling gesture would result in the area encircled by said suitable means to be selected. In this case, instead of a color being selected, a texture or pattern or the equivalent would be saved into memory or to some other storage means where it could then be used to paint over any network media or any part of any network media. This network media or part of network media could include any video, animation, object, link, device, text, background or any other object or visual media that exists for any network. Once the color or texture or pattern or its equivalent has been used to paint over any visibly or invisibly existent data on any network media, the area that was previously occupied by that “visibly or invisibly existing data” can now be utilized by a user for any purpose they desire.

This works much the same as using a selected color, except that the applying of the color is now a texture. The size of the texture is defined by the diameter of the encircling gesture.

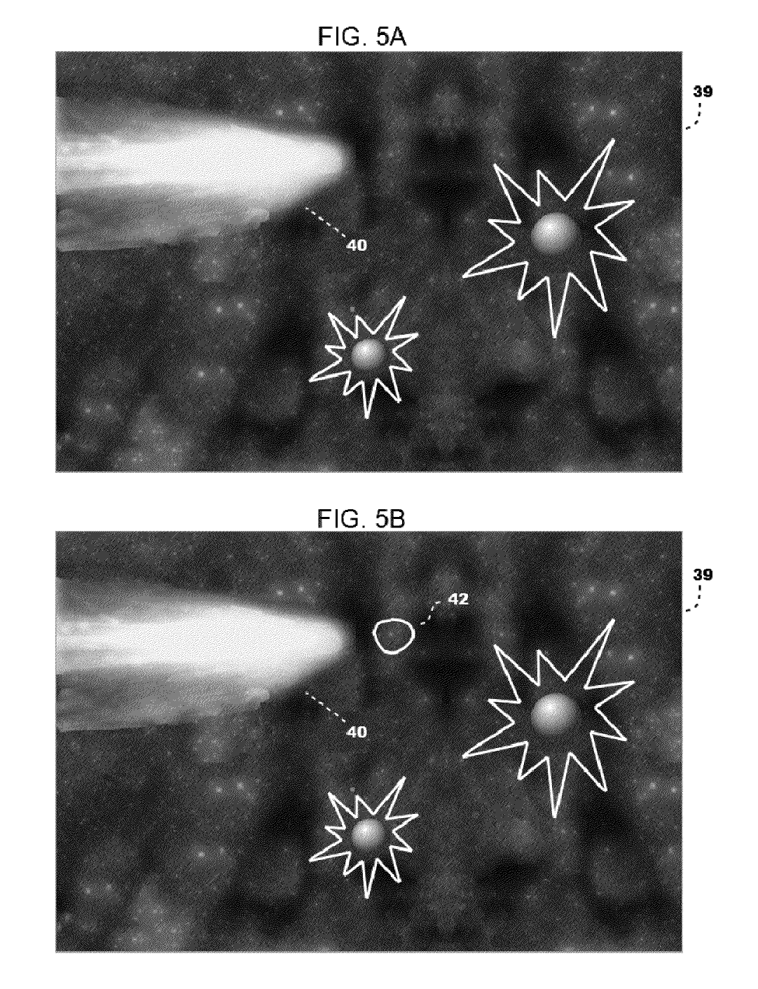

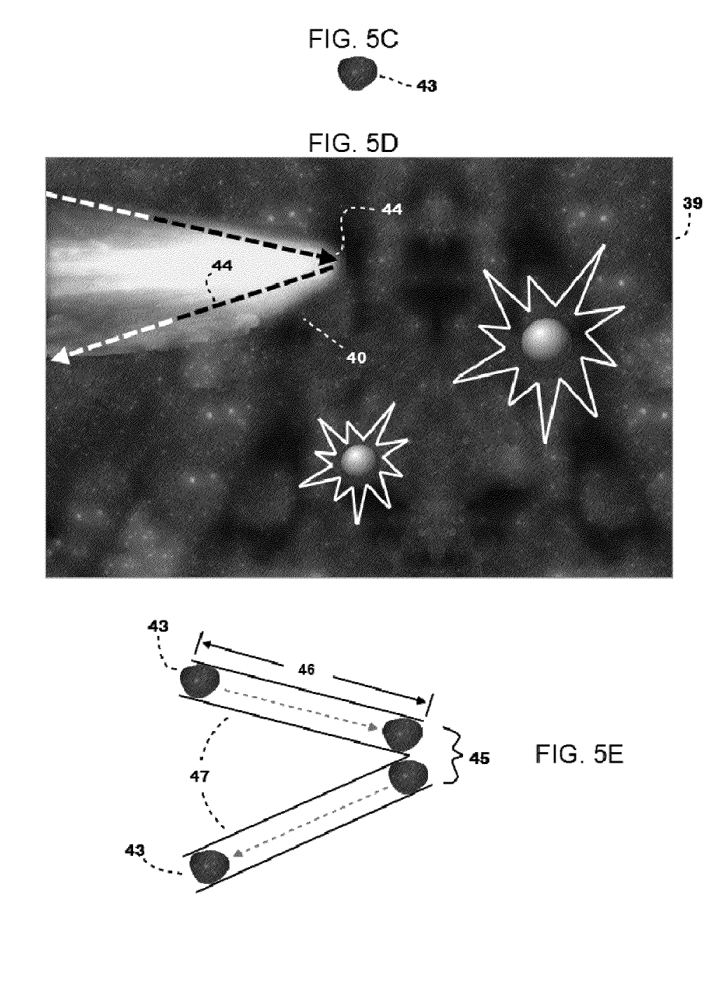

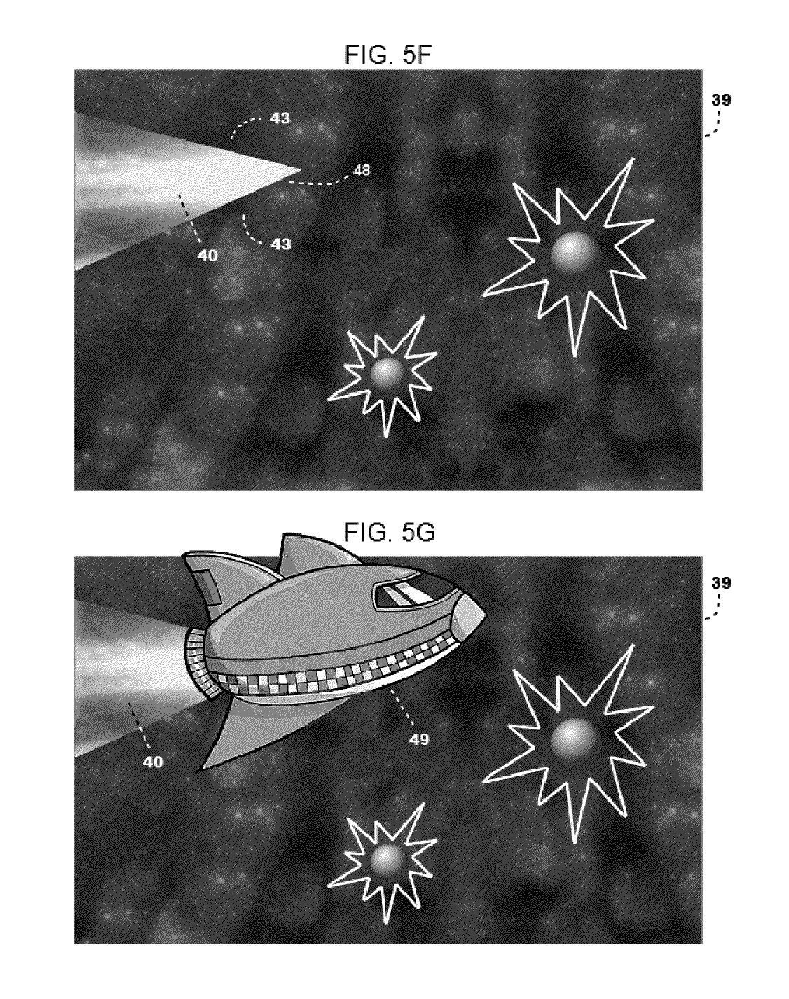

Referring to FIG. 5A, a picture 39 is presented on a website in a VDACC browser, not shown. A video of a comet 40 is presented in the website.

FIG. 5B depicts a gesture 42 that selects a portion of the picture. In this case, the gesture encircles a portion of a star field. The software saves this encircled region of the picture as a texture. Note: a texture can be captured by a gesture that is applied to any media, including videos, slide shows, live collaboration, website backgrounds and any other media.

FIG. 5C shows the selected area of the star field of the picture 39.

FIG. 5D depicts the applying of the texture 43 applied along the paths of the arrows 44 over the video 40. The applying of texture 43 can be accomplished by any suitable means, including drawing with a finger or pen, verbal means, context means, software generated means, preprogrammed means or the like. Regarding context means, the use of a line style (in this example a dashed line) could be a context that automatically engages the applying of the texture 43 to the video 40. Additionally, the simple act of dragging over the video after creating a gesture 42 could comprise a context that causes the texture 43 to be applied to the video 40.

FIG. 5E depicts the applying of texture 43 along two paths. As the texture is applied, it creates an object whose width equals the diameter of the selected texture 43 and whose length equals the distance or length 46 of the drag and whose angle equals the angle 47 of the said application. Said application could include any means known to a computer system, including a drag, drawing or verbal utterance, context, relationship, assignment, context, engaging an object, menu, and the equivalent.

FIG. 5F depicts the result 48 of applying texture 43 to the video 40. As a result of the applying of texture 43, the outer portions of the video 40 are obscured by the star field texture 43. It should be noted that when applying a texture, like texture 43, the software can automatically blend the edges of the texture to the existing background. In this example, the edges of the drawn texture 43 have been blended to match the existing star field in the picture 39. The video 40 would continue to play back, but now the shape of the video 40 has been changed by the applying of texture 43 to it.

FIG. 5G depicts the final user-created personal workspace media. Here a spaceship 49 has been placed over the video 40. The comet tail video 40 has now become the exhaust for the spaceship 49.

In summary, a user can either touch any point on any piece of network media to select a color or create a gesture on any piece of network media that selects a region. It should be noted that this selection process of a color or a region are not limited to network media, but could also be applied to any media. Furthermore, the thickness of the applied selected color, as exemplified in FIG. 4B as object 36, can be determined by any suitable means. This includes, but is not limited to, a selection via a menu or object or device, by verbal means, context means, programmed software means, mental control, gesture means and the like. Note: the placement of the spaceship 49 can either clip into the VDACC browser (not shown) or it can be placed such that part of it appears outside the perimeter of the VDACC browser as shown in FIG. 5G.

Further Concerning the Creation of an Object Using Digital Paint with a Color or Texture.

The action of performing digital paint or the result of performing digital paint can be defined as a software object or result in the creation of a digital object. This result could be a series of connected or individual strokes made with the digital paint. One approach to convert digital paint into a digital object is to take all of the strokes that are within a certain proximity to each other and turn them into a single object. Another approach would be to take all of the strokes that are within a certain proximity to each other and that are the same color or texture and turn them into an object. Another approach would be to create a perimeter derived from one or more digital paint strokes. Then that perimeter would define an object. There are many other ways to define a software object from the use of digital paint. This conversion of one or more digital paint actions (the applying of digital paint) to an object can be easily done as a default action in the software or as a result of a user command or by selection of a menu entry, or upon a user gesture, a computer software command, a context, or the equivalent.

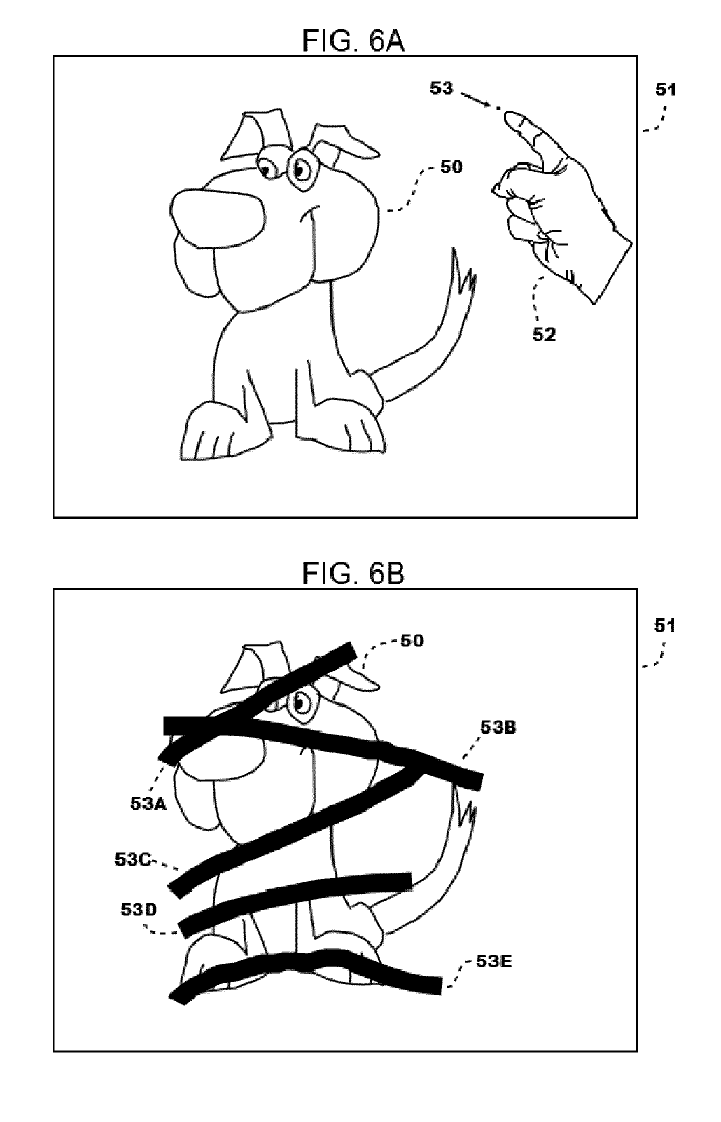

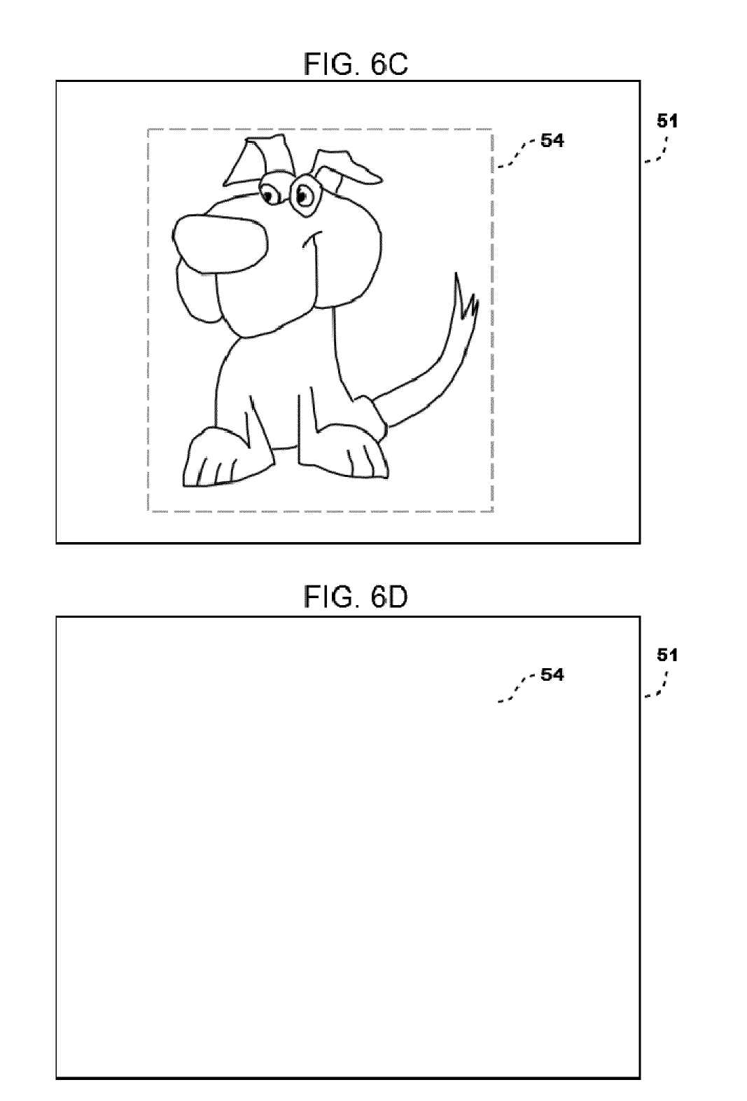

FIGS. 6A-6D are an illustration of the software determining a perimeter from a series of digital paint strokes and then creating an object from the strokes. This operation has many benefits. One would be that if the digital paint is not 100% covering an area, the software could fill in the areas not covered within a determined perimeter area and sloppy painting can result in perfectly recognized digital painted spaces.

FIG. 6A depicts an image 50 in a VDACC browser 51. A finger 52 has touched a point 53 in the VDACC browser 51. The software saves the color of this point. In this case it's the color white. The thickness of the lines that will be produced with this color are determined by any suitable means, including a selection in a menu, via a verbal utterance, a gesture, a context, relationship, software determination, mental input or the like. For the purposes of this illustration, the line thickness will be 72 pixels. Also for the purposes of this illustration, the applied digital paint will be shown as a black line so it's easy to see in these figures.

FIG. 6B depicts the applying of digital paint strokes 53A-53E to the image 50. The applied paint strokes need not cover the entire image 50.

In FIG. 6C the software has analyzed the paint strokes 53A-53E to determine the perimeters of these strokes and has created an object 54 that matches the dimensions of these perimeters. This object also matches the color selected by the finger 52 in FIG. 6A. In this example that color is white. Please note that the object resulting from the use of digital paint can be referred to as a “digital painted space.”

In FIG. 6D object 54 is placed over image 50. The location of object 54 is determined by the perimeters of drawn strokes 53A-53E. Since the color of object 54 matches the background of image 50, image 50 is completely obscured by object 54. This area is now available for a user to place, type, draw, or otherwise fill with any desired digital item, including text, pictures, videos, animations, websites, and any other digital media that can be presented by a digital system. It should be noted that object 54 or its equivalent could be an action, function, drawing, text, picture, video, animation, 3D data, 2D data or any other suitable data.

In another embodiment of this invention, data on a digital painted space (i.e., an object created as the result of applying either a color or a texture or its equivalent to one or more digital items) can interact with data under the digital painted space. In this case, an action, operation, relationship, function or the equivalent can be automatically or manually activated, via context, relationship, gestural means, verbal means or the like to enable such an interaction. One method would be to select a relationship between layers of data. As an example, one layer could be the data under the digital painted space and the other layer could be the data over the digital painted space. The establishing of said relationship can be via any suitable means, including but not limited to, making a selection in a menu, via a verbal utterance, via a gesture, drawing, context, relationship, assignment, preprogrammed operation, software determination, or any other suitable means.

As an example, let's take the two images show in the example above. The original image is underneath a digital paint object, which is the color white on a white background. Please note that this digital paint does not have to exist as a single object. It could exist as any number of strokes or their equivalent. Furthermore, the collective of strokes could be treated as an object or a collective. This collective could be any number of digital paint operations, which could be individual strokes or their equivalent. Another method to define a collective could be to set a perimeter area, which for the examples below could simply be the perimeter of the rectangle which contains one or more objects, actions, functions, etc. The perimeter area could then define an object. That object could be an action, function, drawing, text, picture, video, animation, 3D, 2D or any other suitable data.

There are many benefits of enabling a user to access or operation or in any way interact with data under a digital painted space. For example, a user may wish to create a digital painted space over a graphic on a website that they wish to trace to create a drawing of said graphic. In this case, the digital painted space would likely be made semi-transparent. The user would draw on the digital painted space using the image under it to guide their drawing. At any time in this process the user could make the said image the top layer to better analyze its shapes. After such analysis, the drawing would become the top layer and said graphic would become the bottom layer once again and the tracing could continue.

As another example, a user may use digital paint to cover up a banner ad for a website. At any time the banner ad could be made the top layer so the user could view the ad and then have the ad's layer changed back to a lower layer under the digital painted space. This flipping of layers could be carried out by any means known to the art, including verbal, gestural, drawing, context or software programmed means. The data below and above (if any) a digital painted space could be 2D, 3D or any configuration that can be presented by a computing system or digital system.

In another example, a user may decide to use digital paint to hide active controls, devices, clickable text or objects or the like on a piece of network media. Then they may present their own graphics, text, motion media or the like one this digital painted space. However, the user may at times wish to engage one or more of the active devices under the digital painted space. To do so, the user would change layers to make said devices the top layer and the user-created content a lower layer under said devices.

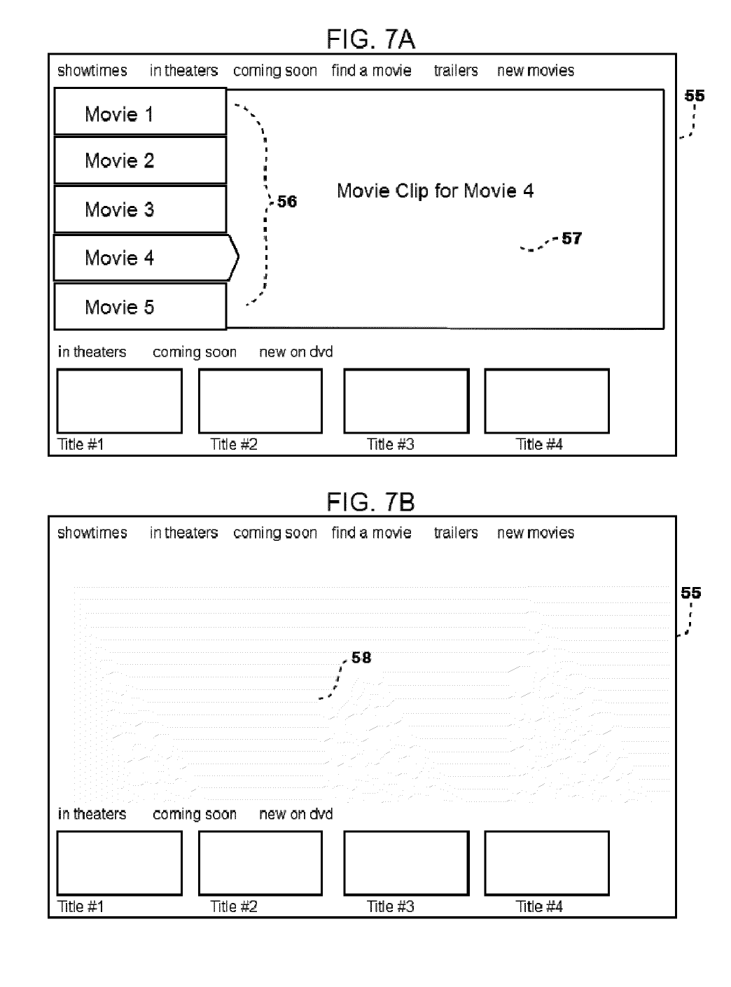

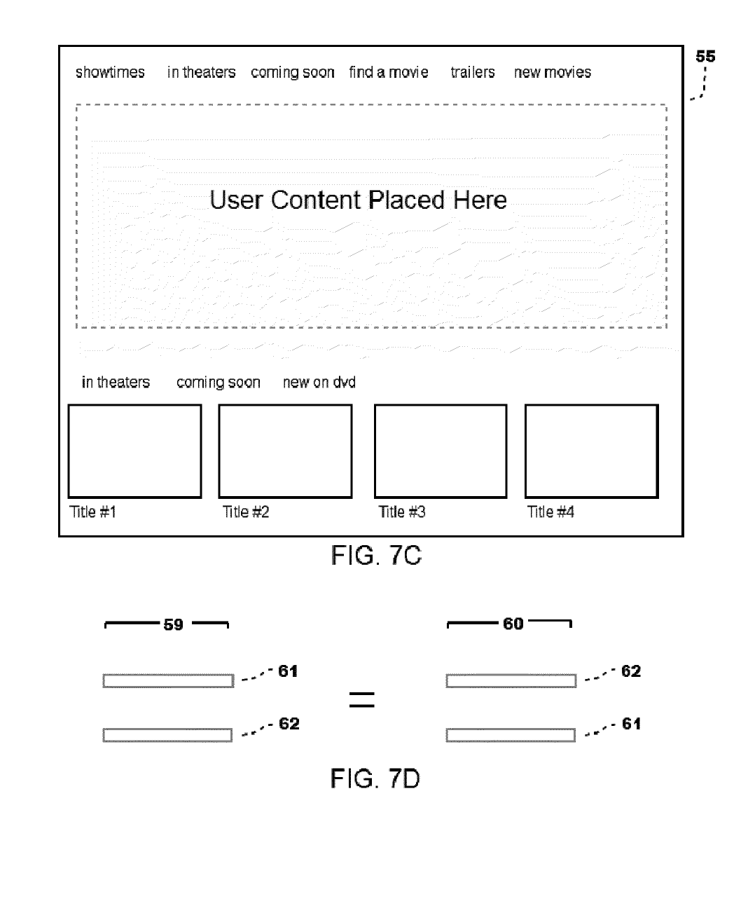

FIG. 7A depicts a website 55 with clickable devices 56. The clickable devices bring forth movies clips to be viewed in area 57.

FIG. 7B shows the result of using digital paint to create a digital painted space 58 to cover up the clickable devices 56 and the area used to show movie clips 57. FIGS. 7A, 7B and 7C show three layers: Bottom layer: the original digital clickable devices on a website. Middle layer: a digital paint object (digital painted space). Top layer: some user-created content placed on the digital painted space.

Any number of possible relationships can be established between the one or more objects under digital paint and the one or more objects over digital paint. There are many ways to establish a relationship. A user could select the digital paint object or the top layer object or both or all layers of objects associated with the digital paint object. Then the user could utter a verbal command, “toggle”. As an alternate to define the toggle action as a relationship, a selection could be made in a menu. Another alternate to define the action toggle as a relationship could be touching or otherwise activating a device, object, text, picture that represents the function “toggle.” The function would then become the relationship between the one or more objects above the selected digital paint object, collective or its equivalent and the one or more objects below the digital paint object, collective or its equivalent.

In this example, a toggle relationship has been established between the layers depicted in FIGS. 7A, 7B and 7C. The toggle function default could be to toggle between the digital painted space (including any objects placed or otherwise presented on said digital painted space) and the clickable devices under the digital painted space. The means of activating the toggle function would include any action, operation, function, or the like that can be activated in a digital system. For example a gesture could cause the clickable devices under said digital painted space to toggle to the top layer where they would be accessible to a user and could be activated as desired. The same gesture could toggle the digital painted space and the objects presented on it to toggle to the top layer and the clickable devices to toggle to a layer below.

FIG. 7D shows a first layer state 59 which is toggled to a second layer state 60. The two layers are a digital painted space 6, including any user content on this digital painted space, and an area of a website 62 containing one or more clickable devices. An input to the digital painted space 61 in layer state 59 toggles the layers such that the digital painted space 61 becomes a layer under said area on a website 60, which becomes the top layer as shown in state 60.

For instance, if a user painted over a banner ad, that area could be used for drawing, typing, painting, placing objects (including pictures, charts, videos or any media for any purpose), rescaling objects, showing the result of verbal dictation, gestures, or anything else that a user may wish to present or clause to be presented in or on their personal workspace. If the user painted over one or more live switches or one or more live links or any other object that has a function, that function is prevented from being activated. By painting over any part of a network media a “digital painted space” is created. Any active device, link, function, operation or the like that exists under a digital painted space continues to exist but it cannot be touched through the digital paint unless otherwise provided for.

In this embodiment, anything that is presented on a “digital painted space” is unaffected by the data that exits under the digital paint. Thus any object, device, function, action, operation, and the like, can be placed, dragged, drawn, typed, presented as the result or a gesture or verbal command or as the result of a computer generated operation of any kind directly over anything on any network media.

ASC (All Selected Content) Device

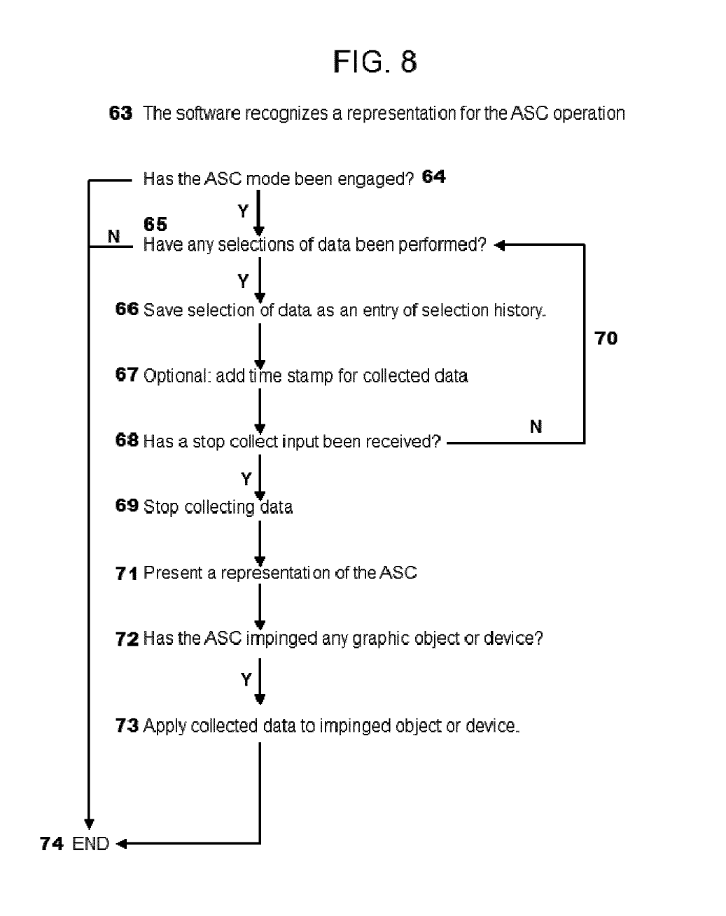

This software enables a user to select any number of pieces of data from any one or more network media, i.e., web pages and websites. The software remembers each selected piece of data and upon an occurrence the software represents this selected data as an object. It can be any object. This object can be created by a user, copied from any source or selected from a list or other suitable collection of data. FIG. 8 is a flowchart illustrating the operation of an ASC device, comprising the following steps:

Step 63. The software recognizes the selection of a representation for the ASC operation, which is the selecting of data. This representation can be a default set in the software or it can be a selection made by the software or by a user from any viable source. This representation can be a graphic object, device or its equivalent, or a function, action, operation, process, implementation, control, software object or its equivalent.

Step 64. The ASC mode has been engaged? This can be done via any means possible in a digital system, including: via gestural means, context, touch, mouse input, activating a device or object, verbal means, mental means or their equivalent.

Step 65. The software checks to see if any selections of data have been performed. Selections of data can be performed by any viable computer input, including but not limited to, mouse inputs, finger inputs on a touch screen and other suitable finger input devices, pen inputs, gesture inputs via any input method (including camera, infra red, proximity, capacitive, sound pressure, and the like), audible inputs.

If “yes,” an input is received by the software as the result of a selection of data being performed. This input can be anything recognized by the software as an indication to start recording, storing, memorizing or otherwise preserving the selection history of data associated with any data source. These sources could include, but are not limited to, any website and web page, server, cloud source, community, document, video, animation, BSP, chart, graph, graphic objects, text, drawings, lines, computer source code, APIs, SDKs and any other viable data source.

If “no,” the process ends at step 74.

Step 66. If a selection of data has been performed, the software saves that selection as an entry of selection history. The data selection can be saved via any suitable means, i.e., memory, hard disk, solid state memory, i.e., flash or to the cloud or server or to any network or its equivalent. The data selection could include any element, item, factor, condition or the like required for performing the data selection. This could include, in part, any one or more of the following: the type of data selected, time of data selection, source of data selection, location of data selection, position of data selection, order of data selection, context of data selection, environment of data selection, and the actual data itself, including the context of the data, the relationship of the data to other data, the environment of the data and anything else that could be associated with the selected data.

Step 67. An optional time stamp can be added for any data selection.

Step 68. Has a stop collect input been received? If “no,” Steps 65 to 68 are repeated for each new selection of data 70. If “yes,” then the software proceeds to Step 69.

Step 69. The software receives an input which causes it to stop collecting data. This input can include: a verbal utterance, a gesture, a drawing, activating a device, activating a graphic, a context, a pre-programmed behavior, an operation that is performed, a timing, etc. The software stops collecting data.

Step 71. The representation of the ASC is presented in a form recognizable by a computer. This form can include, but is not limited to, a display, a graphic object and/or device, one or more audio events, a holographic image or imaging array, a process or operation that has no visual element, computer source code, one or more computer instruction sets, software objects and the like.

Step 72. The ASC is delivered, presented, moved, or in any way made to impact, intersect, impinge any piece of data, function, operation, graphic, device, graphic object, software object, function, operation, action, or any other item or condition that can be recognized by the computer system (“target”).

Step 73. The contents of the ASC, the selected data saved as the selection history for this ASC, are delivered, applied to, presented to, operated upon and the like (“delivered”) to said target.

The means and method of the delivery to the target can be context dependent upon the type of data that comprises the section history for the ASC and the type of target to which the selection history is being delivered. Examples of this delivery could include: impinging a VDACC, menu, list, folder, assigned-to object, any container, any graphic object or their equivalent, such that the selection history is converted to or otherwise present as one of the following:

At least one data element, e.g., pictures, videos, animations, documents, graphs, charts, source code, software, drawings, objects, environments or their equivalent.

At least one selection history event. Said at least one selection history event can be presented in any viable form, including text, graph object, device (physical or graphical), context, relationship, operation, audio file, video, BSP, VDACC, 3-D or 2-D object or environment, holographic presentation or the equivalent. Any said at least selection history event can be activated by any suitable means, including a touch, context, verbal utterance, drawing, and other means described herein.

At least one software program or programmed object or device.

As at least one script or macro.

Managing a Website as the Background of a VDACC

This section describes the architecture used by Blackspace to embed a web browser in the Blackspace content such that it remains fully functional as a browser but is layered correctly with the other content and conforms to the rules followed by other content; such as size, cropping, shape etc.

Graphics Architecture

The graphics architecture is handled by the following:

Graphics Scene

Graphics View

Graphics Scene

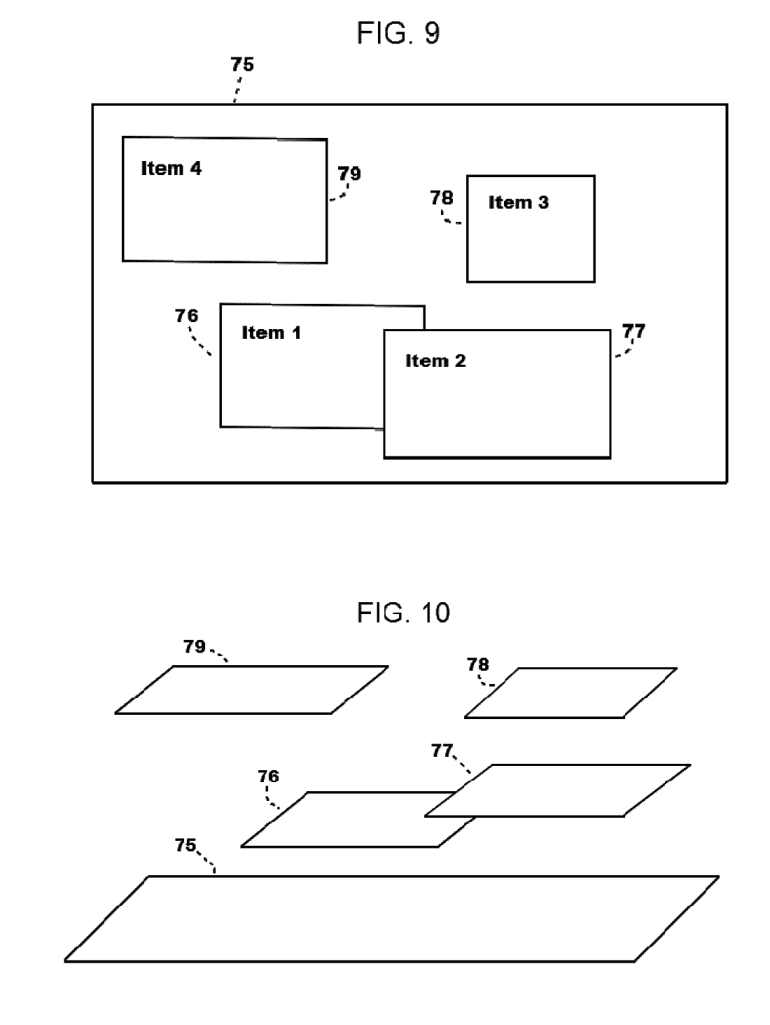

The Graphics Scene is a container for graphics items. It manages the position, layout and order of the items. FIG. 9, illustrates the layout of four items, Item 1, 76, Item 2, 77, Item 3, 78, and Item 4, 79, in a Graphics Scene, 75. Referring to FIG. 10, Graphics Scene, 75, achieves the management of said position, layout and order of items, 76, 77, 78, and 79, by maintaining each item on a separate ‘layer’. In this way it is not possible for two items to be repositioned such that they overlap without any means of determining which item should take precedence (i.e. which item is obscured by the other). The Graphics Scene, 75, is also responsible for event propagation between items. One approach is for inputs (e.g., user inputs, software generated inputs, contextual inputs, automated inputs and the like) to be propagated from top to bottom and according to the coordinates of each input. An event is passed to the uppermost item (e.g., 79, in FIG. 10) whose bounds contain the event coordinates. If the top item, 79, does not process the event, it is passed to the next item down in the stack of items, which also contains the coordinates of the event within its bounds. If an item consumes the event it is not passed to the item immediately underneath it and the event processing of that event is complete.

Graphics View

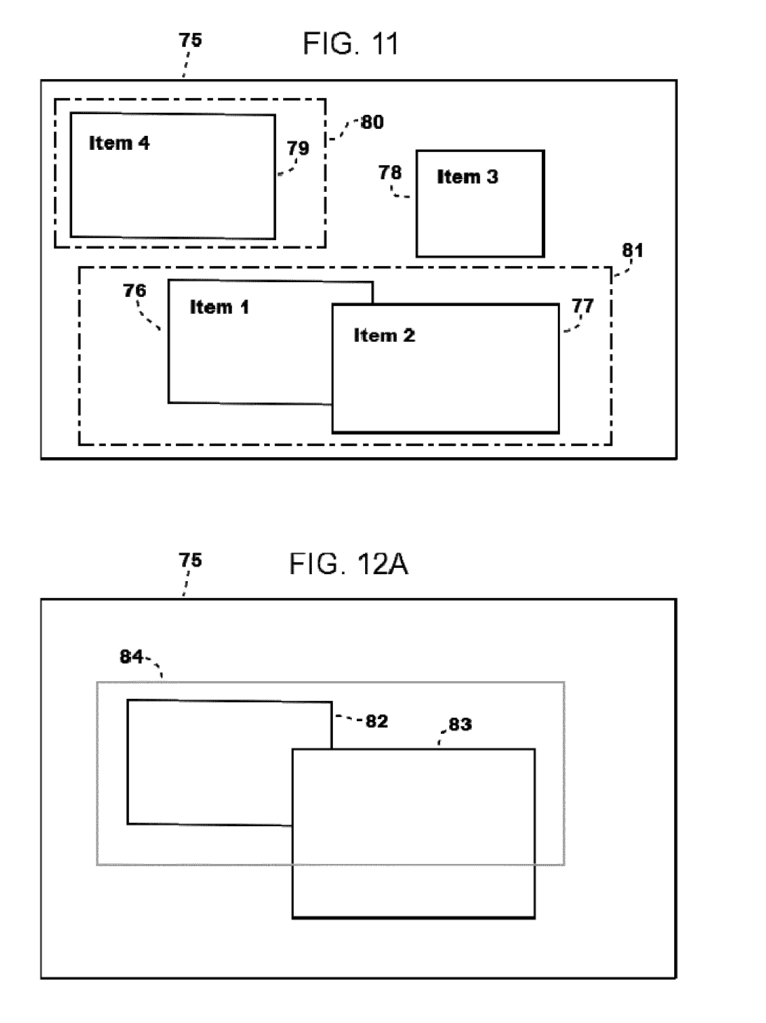

The Graphics View is a viewport (e.g., a partial view) onto a Graphics Scene. Referring now to FIG. 11, Graphic Item, 79, is rendered in Graphic View, 80. Graphic Items 76 and 77 are rendered in Graphic View 81. Said Graphic Items are rendered according to their position, e.g., as defined by coordinates, which is managed by the Graphics Scene, 75. In this way, different transformations can be applied to the Graphics Items in each Graphics View, e.g., 80 and 81. Each Graphics View has its own coordinate system and translates the position of events from View coordinates to Scene coordinates so that they can be handled by the Scene.

Embedded Web Browser

Blackspace embeds a web browser into its layering system as if it were any other object, such as an Image or Text. The Web Browser is self contained within a Graphics Item. It can therefore be interleaved with other Graphics Items in a Graphics Scene. For example, consider a web page constructed from HTML that displays a <form> that is too big for its containing <div> element. If the overflow property of the <div> is set to auto, a normal web browser will display a scroll bar is the contents of the <div> exceed its dimensions. This scroll bar is wholly contained within the web page. As such, the Graphics Scene is not aware of its existence and will not attempt to manage it separately from the rest of the content of the web browser. The web browser item receives events and processes them using its internal coordinates and event handling system. By default, the web browser item will consume all events it receives, since this is the logical behavior users expect of a web browser. Here the word consume means that the events will be processed by the web browser and not passed further to a hierarchy of data and/or objects.

VDACCs

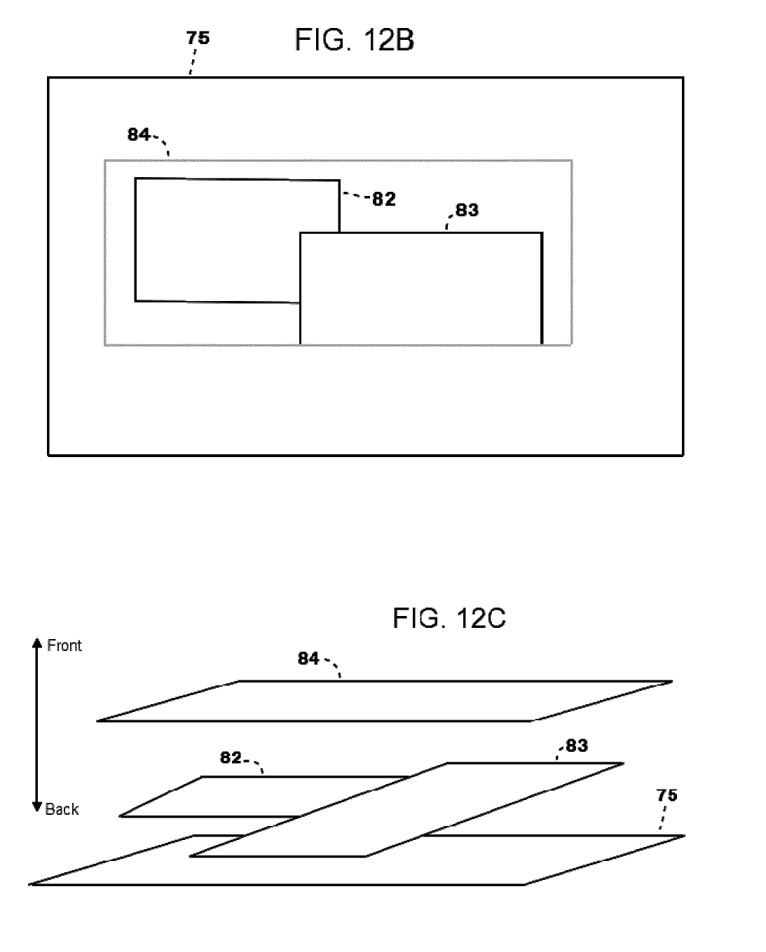

VDACCs are ‘logical’ containers for Graphics Items in Blackspace. They are termed logical because they give the appearance of a container without actually being a container as far as the underlying Graphics Architecture is concerned. The Graphics Scene is the only real container of graphics Items. FIG. 12A shows a Graphics Scene, 75, containing a VDACC, 84, with two ‘children’ VDACCs, 82 and 83. Child VDACC, 83, extends beyond the bottom boundary of parent VDACC, 84. As a result, the lower portion of child VDACC, 83, is cropped by parent VDACC, 84. FIG. 12B, shows the result of child VDACC, 83, clipping into parent VDACC, 84, and being visually cropped by parent VDACC, 84.

The same Graphics Items of FIG. 12B are illustrated in FIG. 12C showing their relative layers. A VDACC may have an opaque or transparent background. If it has a transparent background, events can propagate to underlying objects. If the background is opaque, a VDACC consumes events. Any object that is not managed by a VDACC cannot be interleaved with the content managed by said VDACC. In other words, content can exist on any layer in a VDACC and be successfully interleaved with any other content managed by said VDACC.

Web Browser

Blackspace enables a web browser to be the background for a VDACC by placing it on the lowest layer of the VDACC. Said web browser can fill any portion of a VDACC, or extend beyond the boundary of the VDACC, such that the VDACC forms the clipping region for the web browser. Other items may be placed inside the VDACC, on top of the web browser. These items will be rendered on top of the browser and clipped to the boundary of the VDACC.

Personal Workspaces as the Next Generation of Data Management

Personal workspaces can be used for research for schools and universities and other educational institutions as well as for individuals and business. One use of personal workspaces would be to replace “favorites” as a way to navigate to preferred websites. An example of this would be as follows.

A user finds a website that contains some of the information they wish to utilize, study, analyze and organize for a school assignment or for any use. Then they search the internet for other websites that contain additional information that they need to supplement the information they found in the first website. As each new website is found, that website is navigated to the page containing the needed information. Then this website is dragged or otherwise placed into the first website. In the software of this invention all websites are objects. The first website is turned into an object and placed into an environment created by the software of this invention. The second website is turned into an object and is placed into the same environment. It appears to the user that the second website is inside the first, but in point of fact both websites exist in the same software environment. Even though these websites are treated as objects in the software, they exist as live websites which can be navigated, operated and otherwise interacted with.

As a user continues to find more websites that contain more information, these websites are added to the existing website environment. To access this environment, a user can type or otherwise access the URL for the first website and by this means gain access to all of the other websites that were added to that website environment. Thus instead of having a list of favorites in a web browser, the user has a customized set of actual live websites organized according to their own wishes.

User Account:

Each user of this software has a user account. The account includes information that identifies the user. This information could include a user name and a password and other information that is deemed appropriate or valuable. When a user enters a specific URL the software checks that URL against that user's ID information to see if any user-generated content exists for that URL. If the software finds user-generated content for a URL that was entered by a user, then the user-generated content for that URL is presented in the website environment for that URL. This means that the URL for a personal workspace needs to be entered either from within the software of this invention or in some way associated with the software of this invention. If the URL is entered outside the software of this invention or not in any way associated with the software of this invention, the user sees the original website without any user-generated content. If another user enters the same URL inside the software of this invention, and they have created their own user-generated content for the website belonging to that URL, their user-generated content will appear in the website environment. Thus each user can utilized the same website for their own personal workspace and see only their own user-generated content when accessing the same URL.

New Analytics

Personal Workspaces supply a new genre of analytics. Personal workspaces afford new patterns of use that can reveal new information regarding the use of data. For instance, what parts of a network media are being covered up by digital paint? Why does a user cover up what he or she does? Why does the user leave other items visible and/or active in a parent network media, like a parent website? What types of data does a particular user add to a network media? Where is this data added in the personal workspace? What shapes does this data take? How is layering used and to what extend? How are assignments used and to what end and to what extent? What objects are chosen as assigned-to objects? Where are these objects placed in the personal workspace? What types of data are assigned to objects by the user? What types of websites are added to a personal workspace? Where are the websites navigated to before they are added to the personal workspace? What types of annotations, text and/or drawing are added to a personal workspace? What text is underlined or highlighted? What images or links or devices are encircled or commented? How is the data in the personal workspace organized? What tools were used to organize this data?

The answers to these questions and many more can be useful in the educational arena. For instance, what if a student handed in not only their assignment or project, but also their personal workspace that they used to do their research, analysis, and learning that led to the completion of their school assignment or project. The teacher would now have access to an environment that could reveal much about the thought process of the student.

One key to education is teaching a student how to learn. Typical tests, especially multiple choice tests, so common among standardized tests, don't show the student's thought process. But access to their personal workspaces could reveal much about how the student tackled a problem, how they accessed information, how they organized that information, what was important to them and what was not. This could speak volumes about that student's ability to process information and that could enable a teacher to better help them understand how to better acquire knowledge and effectively utilize that knowledge.

In summary, personal workspaces offer a way to view both a user's content and said user's thought processes utilized in creating said content. Further, a personal workspace can afford the opportunity to analyze and attempt to understand a user's thought process and thus enable a teacher, business associate, mentor, employer and the like, to better assess, help, instruct, guide and direct said user.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

Although specific embodiments of the invention have been described and illustrated, the invention is not to be limited to the specific forms or arrangement of parts so described and illustrated. The scope of the invention is to be defined by the claims appended hereto and their equivalents.

What is claimed is:

1. A method for modifying digital media with digital content, said method comprising:
presenting at least one VDACC browser to a digital system; and
presenting at least one network media in said VDACC browser; and
presenting at least one digital content to said network media in said VDACC browser.

2. The method of claim 1 wherein said network media exists as the background for said VDACC browser.

3. The method of claim 2 wherein said network media is a website.

4. The method for claim 1 further comprising:
inputting at least one stroke to said network media in said VDACC browser;
analyzing aid stroke to determine its perimeter dimension; and
using said perimeter dimension to create a digital paint space associated with said network media in said VDACC browser.

5. The method for claim 1 further comprising:
inputting a gesture to said network media in said VDACC browser;
analyzing said gesture to determine a section of said network media outlined by said gesture; and
applying said network media outlined by said gesture as a texture; and
utilizing said texture to create a digital painted space associated with said network media in said VDACC browser.

6. The method for claim 1 wherein said VDACC browser can be toggled with said network media.

7. The method of claim 1 wherein said at least one digital content is used to create analytics for at least one user.

8. A method for modifying digital media with digital content, said method comprising:
employing at least one graphics scene;
employing at least one graphics view; and
embedding a web browser into a layering system;

9. The method of claim 8 wherein said web browser is interleaved with at least one other graphics item in a graphics scene.

10. The method of claim 8 wherein said graphics scene contains at least one VDACC.

11. The method of claim 10 wherein said web browser is the background for said VDACC.
